(19) United States
(12) Patent Application Publication
(10) Pub. No.: US 2026/0187377 A1
(43) Pub. Date: Jul. 2, 2026

(54) CONSENSUS-BASED DETERMINISTIC AGENTIC SYSTEM

(71) Applicant: American Express Travel Related Services Company, Inc., New York, NY (US)

(72) Inventors: Andras L. FERENCZI, Scottsdale, AZ (US); Allwyn PONNUDURAI, Phoenix, AZ (US); Sibish BASHEER, Phoenix, AZ (US)

(73) Assignee: American Express Travel Related Services Company, Inc., New York, NY (US)

(21) Appl. No.: 19/007,075

(22) Filed: Dec. 31, 2024

(51) Int. Cl. G06F 40/40

(52) U.S. Cl. CPC G06F 40/40

(57) ABSTRACT

Disclosed herein are system, method, and device embodiments for deploying a highly reliable, consensus-based agentic AI system that processes natural language requests to provide deterministic, consistent, and verifiably accurate responses. The agentic AI system may prioritize reliability, transparency, trustworthiness, and deterministic behavior using structured communication, consensus mechanisms, and a scalable design. The capability to provide deterministic behavior and consistent outcomes may make the consensus-driven genetic AI tool especially suitable for applications requiring high levels of accuracy and trust.

### BACKGROUND

Artificial intelligence (“AI”) is a field of computer science that allows machines to use learning and human-like judgment to accomplish goals. These goals may be varied and far-reaching. For example, applications that leverage AI may include virtual assistants, fraud detection tools, autonomous vehicles, facial recognition software, financial tools, medical devices, and other applications across a wide-array of other industries and use cases.

Generative AI is a subset of AI that uses machine learning models to produce text, images, videos, and other content in a manner that approximates human creation. Such models may include large language models (“LLMs”) trained on vast amounts of data using unsupervised or self-supervised learning techniques. LLMs may be trained on words or word tokens, programming language text, image inputs, audio data, video data, and other suitable data to learn patterns, behaviors, and tendencies. Based on the training, the LLM may derive new data. Generative AI has many applications in content creation, software development, sales and marketing, and other creative endeavors.

When generating content, generative AI tools may create incorrect, misleading, or unintelligible results. Such errors may be referred to as “hallucinations.” For example, a generative AI may make up facts, identify false negatives/positives, predict an event that is unlikely to happen, create nonsensical images, etc. Hallucinations may be problematic for a variety of reasons, e.g., such errors may undermine humans’ trust in the tools and contribute to the spread of misinformation. In high-stakes situations where accurate results are necessary, such hallucinations may be especially unacceptable, problematic, or dangerous.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a block diagram of an environment for implementing a consensus-based, deterministic, agentic AI system, according to some embodiments.

FIG. 2 is a block diagram of a consensus-based, deterministic, agentic AI system, according to some embodiments.

FIG. 3 illustrates a method for processing a natural language request with a consensus-based, deterministic, agentic AI system, according to some embodiments.

FIG. 4 illustrates a method for determining if a received natural language request is deterministic, according to some embodiments.

FIG. 5 illustrates a computer system, according to exemplary embodiments of the present disclosure.

The present disclosure will be described with reference to the accompanying drawings. In the drawings, like reference numbers indicate identical or functionally similar elements. Additionally, the left-most digit of a reference number identifies the drawing in which the reference number first appears.

### DETAILED DESCRIPTION OF THE INVENTION

Provided herein are system, apparatus, device, method and/or computer program product embodiments, and/or combinations and sub-combinations thereof, for deploying a highly reliable, consensus-based agentic AI system that processes natural language requests and provides deterministic, consistent, and verifiably accurate responses. The agentic AI system may be configured to prioritize reliability, transparency, trustworthiness, and deterministic behavior using structured communication, consensus mechanisms, and a scalable design. This capability may provide deterministic behavior and consistent outcomes makes the consensus-driven genetic AI tool especially suitable for applications requiring high levels of accuracy and trust.

Generally speaking, agentic AI tools may provide generative AI functionality by leveraging distributed agents. Agentic AIs may be single-agent or multi-agent systems. A single-agent system may employ a single LLM or other computational model. A multi-agent system may employ multiple agents to achieve the generative AI functionality. Each agent may be tasked with performing a different role and have a different LLM (or other suitable computational model), codebase, design architecture, etc. In AI-based tools, the particular agents/LLMs may access application programming interface (“API”) functions via function calls. The APIs may be housed within an organization’s technical infrastructure or externally available. For example, an agent may access a database of customer information to provide content that includes customer information, may access an API to complete financial transactions, may receive real-time information about weather conditions, traffic, etc., and may access a wide-array of other functionality to supplement content generated by the model.

Consensus algorithms may be programmatic methods of achieving agreement across nodes of a decentralized computer network. For example, consensus algorithms may be used for recordkeeping in blockchain-based tools, to reliably store data in large-scale, distributed systems, and in many other scenarios involving computer networks where agreement about any “truth” needs to be reached across nodes of the network. Various consensus algorithms exist including proof-of-work, proof-of-stake, PAXOS, ETCD/RAFT, Practical Byzantine Fault Tolerance (“PBFT”), etc.

A task language may be a scheme that represents human language and instruction in a machine-readable format. A task language may enable a robot or computer to work with humans using human language and follow instructions in a broad context. Various task language implementations have been developed, including the Task Language with predicate Representation (“TALAR”) method.

These technologies—i.e., (1) genetic AI, (2) consensus protocols, and (3) task languages—may provide an opportunity to improve upon legacy generative AI technologies. Specifically, legacy generative AI tools are known to hallucinate, i.e., create incorrect, misleading, or unintelligible results. Moreover, legacy generative AI tools are not deterministic and do not provide consistent results, i.e., a first result provided in a response to a query may not match a second result provided in response to the same query.

This tendency of generative AI tools to hallucinate is a known problem. Legacy approaches to minimizing or eliminating hallucinations may include: accessing external knowledge bases to fact check responses, refining or correcting prompts, deploying task-specific AI models, retraining models with additional data, etc.

However, no legacy technique minimizes hallucinations and provides consistent results using agents that each may derive a response and agree on the truthfulness of their independently derived responses using a consensus algorithm. By converting natural language to a task language and employing a consensus protocol to check other agents’ work, the agentic AI tool of the present disclosure may minimize or eliminate hallucinations and provide deterministically verifiable responses to natural language requests.

Towards this end, both a primary agent and replica agents in the disclosed agentic AI tool may be deployed with the PBFT protocol or other suitable consensus-building mechanism and a task language generator/interpreter. In one embodiment, the PBFT protocol and the task language generator may be deployed as a single library. All agents may understand requests identically and arrive at validated responses. The agents may then reach a consensus among themselves as to the trustworthiness of the generated responses. This allows the agentic AI tool to validate responses, prevent hallucinations, and guarantee trustworthy outcomes when providing responses to natural language requests.

Some legacy systems may employ multiple autonomous agents. However, in such legacy multi-agent systems, each agent may perform specialized, non-overlapping tasks. The agents then collaborate towards a composite response by assembling their work products. Each agent may have its own unique LLM or other computational model. For example, a first agent may handle natural language processing, a second agent may handle accessing a database API, etc. This specialization may increase the efficiency and scalability of multi-agent systems.

However, the purpose of legacy multiple agent systems is not to guarantee a trusted answer but to have a conversational/interactional approach to solve component aspects of a particular problem. Existing tools may rely on an individual or primary agent to make decisions based on their own models leading to potential inconsistencies and a lack of transparency. Such systems may struggle with ambiguous language and fail to provide reliable outcomes if adversarial inputs are provided. Some agentic systems may include feedback loops that allows the agents to learn from their outputs and refine their processes. Such tools may exchange outputs and iteratively improve the response. However, such tools may not include the same codebase and may not perform identical functions to deterministically compare generated responses.

Thus, a technical benefit may be realized by deploying each agent with matching computational models and with the same codebase (including both a consensus mechanism and a task language generator). Each agent may then redundantly derives a solution to the task language and compares the responses to other agents through the shared consensus mechanism. The consensus mechanism may be similarly deployed at each replica agent. Each agent may be configured to run the same logic and cross-checks the results (similar to a blockchain or decentralized solution). In an embodiment, the process of building a consensus may include distinct phases: e.g., a PBFT Request, Pre-Prepare, Prepare, Commit, and Reply.

A further technical benefit may be realized by grouping deterministic agents into clusters. In such a technique, each cluster may represent a PBFT (or other suitable consensus protocol) implementation. Each agent may have a matching copy of any computational models and operates with the same codebase, ensuring consistent logic. Each agent may receive the task language representation and process it independently. In this manner, specialized deterministic agents may act as clusters of PBFT setups to further enhance scalability and robustness. The resulting genetic AI tool may be accurate, transparent, deterministic, scalable, and resilient.

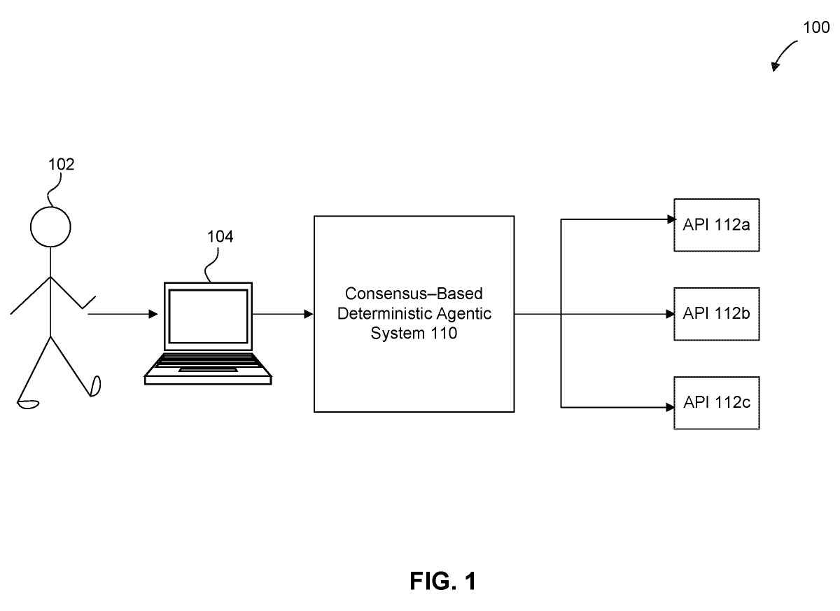

FIG. 1 is a block diagram of environment 100 for implementing a consensus-based, deterministic, agentic AI system, according to some embodiments. As illustrated in FIG. 1, environment 100 may include user 102, device 104, agentic AI system 110, and APIs 112a-112c.

User 102 may be an individual interacting with agentic AI system 110. For example, user 102 may be human being accessing an AI tool such as a virtual assistant. User 102 may also be an external AI construct or being. User 102 may provide a natural language based request to agentic AI system 110. The request may be a request for information, to complete a task, to generate text, software, video, audio, or multimodal content, etc. The natural language may be English or any suitable language. For a further example, user 102 may enter natural language request as part of a transaction request. Examples of transaction requests may include: making a payment by transferring money or digital property such as cryptocurrency, moving money between accounts, generating invoices, sending reminders for payments due, purchasing or selling securities or other financial instruments, and other suitable requests.

Device 104 may be a personal digital assistant, desktop workstation, laptop or notebook computer, netbook, tablet, smart phone, mobile phone, smart watch or other wearable, appliance, part of the Internet-of-Things, and/or embedded system, to name a few non-limiting examples, or any combination thereof. Device 104 may connect to agentic AI system 110 using a suitable network such as the Internet, a local area network (LAN), a wide area network (WAN), a wireless network, a cellular network, or various other types of networks as would be appreciated by a person of ordinary skill in the art. Although device 104 is illustrated in the example of FIG. 1 as a single computer, one skilled in the art(s) will understand that device 104 may represent two or more computers in communication with one another. Therefore, it will also be appreciated that any two or more components of device 104 may similarly be executed using some or all of the two or more computers in communication with one another.

Agentic AI system 110 may process natural language requests to provide deterministic, consistent, and verifiably accurate responses. Agentic AI system 110 may deploy agents with the PBFT protocol or other suitable consensus-building mechanism and a task language generator/interpreter. Agentic AI system 110 may deploy each agent with matching computational models and with the same codebase. In an embodiment, the codebase may include task language generation logic, agent cluster management code, communication protocol handling (i.e., an event bus/network), error detection and recovery mechanisms, and other suitable modules. The task language generation logic may include the neural network architecture that is responsible for converting natural language requests into a standardized format (e.g., a binary format) to ensure uniform understanding across all agents. The agent cluster management code may include modules that manage the clustering of deterministic agents into PBFT setups—e.g., for selecting and coordinating primary nodes, handling message passing between replicas within clusters, and maintaining fault tolerance mechanisms. Given the reliance on fast and reliable communication, communication protocol handling may facilitate efficient exchange of messages during the consensus process among agents, ensuring that PBFT phases like pre-prepare, prepare, and commit may be executed efficiently without significant delays. Because agentic AI system 110 prioritizes reliability, the error detection and recovery mechanisms may handle potential issues such as message loss or corrupted data during communication between nodes or within clusters of deterministic agents.

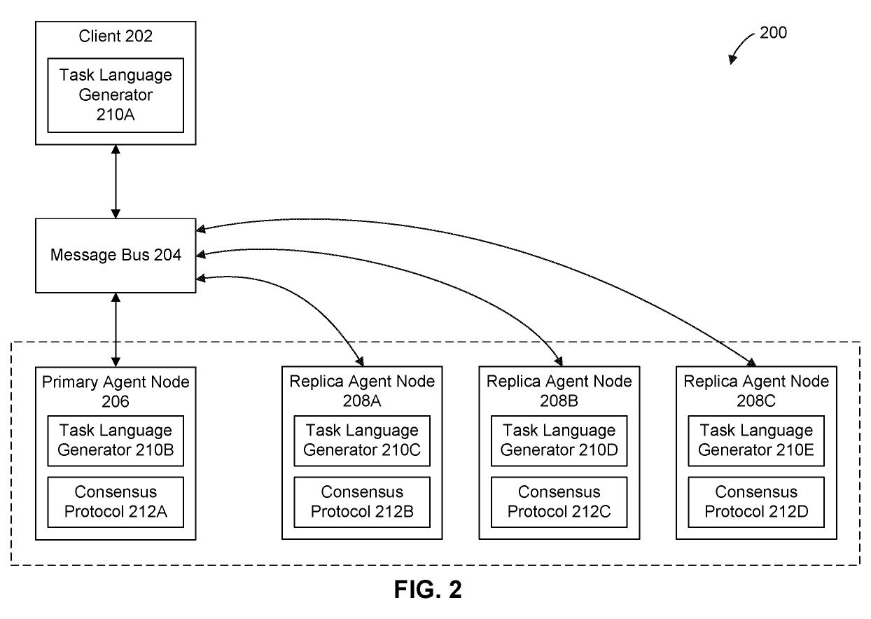

In an embodiment, the computational models may be LLMs. However, in an alternative embodiment, the agents may use lightweight models, transformer-based models, state-spaced models, or other suitable models. In an embodiment, the consensus-building mechanism and the task language generator may be bundled together in a single software library. Each agent deployed by agentic AI system 110 may understand requests identically, and the agents reach a consensus among themselves as to the trustworthiness of the generated responses. Agentic AI system 110 may then provide validated responses to received natural language requests. Agentic AI system 110 is described in further detail below with reference to FIG. 2.

APIs 112a-112c may be APIs and other systems within an organization’s technical infrastructure that may be accessed using a function call. For example, an agent in agentic AI system 110 may access a variety of specialized APIs based on the unique features and functions available to a customer and within an industry. Such APIs may provide access to internal databases and other sources of information. APIs 112a-112 may also be externally provided APIs. Overall, APIs 112a-112c may allow agentic AI system 110 to access domain-knowledge in forming responses to natural language requests and to perform actions based on natural language requests.

FIG. 2 is a block diagram of a consensus-based, deterministic, agentic AI system 200, according to some embodiments. As illustrated in FIG. 2, agentic AI system 200 may include client 202, message bus 204, primary agent node 206, replica agent nodes 208A-208C, task language generator 210A-210E, and consensus protocol 212A-212D. Generally speaking, agentic AI system 200 may be deployed in a decentralized fashion or a centralized fashion.

Client 202 may be a client interface through which device 104 may interact with agentic AI system 200. Client 202 may receive natural language from device 104. Client 202 may include task language generator 210A. Client 202 may feed the natural language received from device 104 into task language generator 210A to generate a binary, task-language representation of the natural language. Client 202 may then transmit the task language to an appropriate deterministic agent cluster. Client 202 may transmit the task language to one or more nodes in the appropriate deterministic agent cluster. For example, client 202 may transmit the task language to a designated or nominated primary node, such as primary agent node 206. While FIG. 2 only illustrates a single cluster of agents (as indicated by the dotted line encompassing primary agent node 206 and replica agent nodes 208A-208C), this is merely for ease of illustration, and multiple agent clusters of deterministic agents may be deployed. Each cluster may represent a PBFT (or other suitable consensus protocol) implementation. Deploying clusters of PBFT setups may enhance the scalability, robustness, and resiliency of agentic AI system 200.

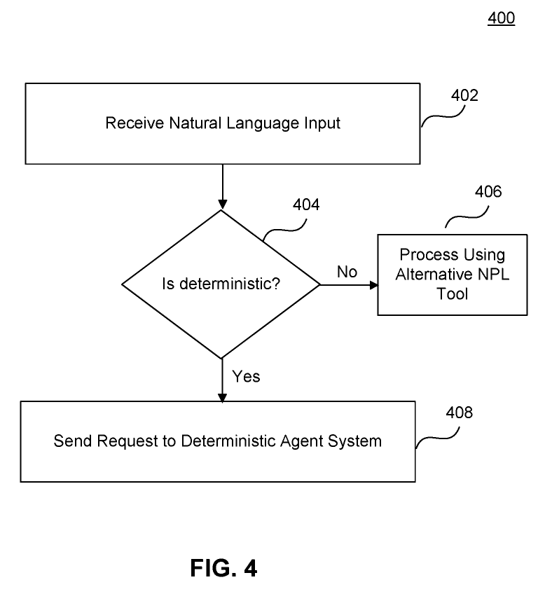

Additionally, client 202 may reach a threshold determination regarding the ability of agentic AI system 200 to process a particular natural language request. Client 202 may need to make such a threshold determination because not all natural language requests may be processed by agentic AI system 200. For example, while deterministic requests, scientific queries, yes/no questions, etc. may be answered, agentic AI system 200 may be unable to process requests that are open-ended or non-deterministic. In one approach, client 202 may be able to determine whether a received request corresponds to capabilities trained into the task language. For example, client 202 may determine that agentic AI system 200 may not be able to process a natural language request of “summarize the following document . . . (document),” but may be able to provide a deterministic answer to a natural language request of “is the topic of the following document the French Revolution . . . (document)”? This capability of client 202 is described in further detail below with reference to FIG. 4.

Message bus 204 may be an event bus, router, messaging service, message queue, event stream, or other suitable communication methodology that facilitates fast and reliable communication between agents and client 202. Message bus 204 may facilitate communication between agents within each deterministic agent cluster. Message bus 204 may also facilitate communication between client 202 and one or more nodes in the agent cluster. For example, message bus 204 may be Kafka-based solution. In an embodiment, message bus 204 may enable an efficient exchange of messages during a PBFT consensus process. As discussed above, FIG. 2 only illustrates a single cluster of agents. This is indicated in FIG. 2 by the dotted line encompassing primary agent node 206 and replica agent nodes 208A-208C. However, multiple clusters of deterministic agents may be deployed. In a multi-cluster implementation, each cluster may leverage a distinct message bus, network, or other suitable communication methodology to facilitate intra-agent communication within that cluster. Additionally, FIG. 2 illustrates client 202, primary agent node 206, and replica agent nodes 208A-208C co-located on the same message bus (message bus 204). In such a configuration, a standard cloud offering may be used to enhance performance, although the necessary handshake may be performed in full decentralized platforms. Although not illustrated in FIG. 2, client 202 may be hosted externally but still capture the messages from primary agent node 206 and replica agent nodes. In yet another embodiment, each agent and client 202 may be separate entities.

Primary agent node 206 may be a designated, nominated, or rotating node within agentic AI system 200 that may act as the coordinator when responding to a natural language request. Primary agent node 206 may generate a preliminary or candidate response to task language generated/translated from the request natural language request. Primary agent node 206 may initiate consensus building by sending messages to replica agent nodes 208A-208C. Primary agent node 206 may collect responses from replica agent nodes 208A-208C. Primary agent node 206 may include a suitable model such as an LLM, a lightweight models, transformer-based models, state-spaced models, or other suitable models to allow primary agent node 206 to generate a candidate response to a natural language request.

Replica agent nodes 208A-208C may be separate nodes (distinct from primary agent node 206) within agentic AI system 200 that independently receive the task language corresponding to the natural language received from device 104. Each agent in replica agent nodes 208A-208C may store a matching copy of any computational models deployed on primary agent node 206. This may allow replica agent nodes 208A-208C to each operate on the same codebase, ensuring consistent logic. Each agent in replica agent nodes 208A-208C may independently evaluate the task language and understand requests identically. Towards this end, each agent in replica agent nodes 208A-208C may redundantly derive a solution to the task language. The agents may then compare the responses (generated in task language) via the consensus mechanism.

Primary agent node 206 and replica agent nodes 208A-208C may be members of particular clusters of agents. In various embodiments, agents in the same cluster may run as a separate virtual machines on a physical machine or as separate containers/pods/etc. on a single host machine. In another embodiment, agents in the same cluster may run on separate physical machines.

Task language generator 210A-210D may convert received natural language to a task language. Such a task language may be a task-related scheme that represents human language and instruction in a machine-readable format. Task language generator 210A-210D may employ a shared model (e.g., a recurrent neural network or transformer) to convert natural language into a standardized binary representation, i.e., into the task language.

In an embodiment, task language generator 210A-210D may be represented by a neural network including multiple predicate modules (“PMs”). Each PM may be responsible for extracting arguments from an input state pair and determining the Boolean values of predicates based on the extracted arguments. The arguments may be extracted using fully-connected networks ending with a Gumbel-Softmax activation layer that outputs a discrete one-hot vector representing an anonymous object. Multiple PMs may be used to determine the Boolean values for the predicates. The PMs may then share parameters, ensuring consistent relations among various arguments. Task language generator 210A-210D’s final output may be a discrete binary vector formed by concatenating the outputs from all the PMs.

Task language generator 210A-210D may be trained to ensure that the generated task language captures crucial aspects of a given state transition. For example, the TALAR system employs masked language modeling for this purpose. The tool may predict the masked parts using state transitions. In an embodiment, the translation of natural language to task language may be achieved using variational auto-encoding (“VAE”). VAE may consist of an encoder (that takes the natural language as input and generates a latent encoding) and a decoder (that recovers the task language from the latent encoding). Task language generator 210A-210D may be trained to minimize a specific loss function to ensure that the task language recovered from natural language is as close as possible to the original task language generated by the task language generator. This training may make the translation robust, particular for unseen natural-language expressions. The recurrent nature of processing natural language (which involves variable-length sequences) may be handled by encoding each word as an embedding and processing these embeddings using a recurrent model or a transformer-based model like Bidirectional Encoder Representations from Transformers (“BERT”). BERT is a transformer model that is pre-trained and used to tokenize NL sentences and extract sentence embedding features. These embeddings may serve as input to the encoder for translation into the task language. Generating the task language in predicate representation combined with a robust translation model may allow task language generator 210A-210D to effectively translate diverse natural-language instructions into a structured, task-specific language that may easily be interpreted and acted upon by a reinforcement learning policy.

Consensus protocol 212A-212D may be a consensus algorithm at the core of each deterministic agent cluster. Consensus protocol 212A-212D may ensure agreement among agents, e.g., as conducted in recordkeeping in blockchain-based tools. Via consensus protocol 212A-212D, agents (i.e., primary agent node 206 and replica agent nodes 208A-208C) may propose responses based on their own individual processing of the task language generated by task language generator 210A. The proposed responses may then be compared and validated through a series of messages exchanges among the agents. Only responses that are agreed upon by a quorum of agents via consensus protocol 212A-212D may be considered valid. In an embodiment using the PBFT algorithm, these messages exchanges may be Pre-prepare, Prepare, and Commit messages.

The PBFT algorithm may ensure agreements among nodes in a distributed system, even if some nodes are compromised, faulty, or acting maliciously. In a distributed system with 3f+1 nodes using the PBFT algorithm, a consensus may be reached if no less than 2f+1 nodes are functioning normally. This tendency makes it useful for systems requiring high levels of reliability and scalability such as blockchain networks, financial services, supply chain management, and other high-stakes use cases. The PBFT algorithm may provide high fault tolerance, deterministic outcomes (all honest nodes will agree on the same outcome leading to a consistent system state), and a relatively simple implementation compared to other consensus algorithms, but any suitable consensus protocol may be employed to achieve the disclosed techniques.

Although illustrated as separate components, in one embodiment, consensus protocol 212A-212D and task language generator 210A-210D may be deployed as a single library.

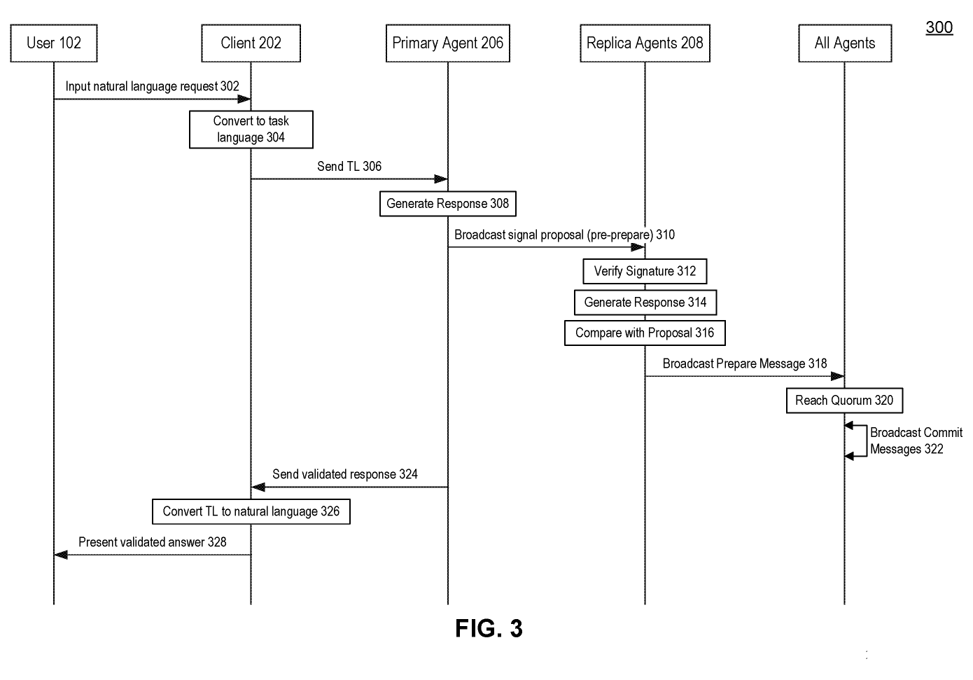

FIG. 3 illustrates a method 300 for processing a natural language request with a consensus-based, deterministic, agentic AI system, according to some embodiments. Method 300 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art(s).

In 302, client 202 may receive a natural language request from device 104. The natural language request may cover a multitude of scenarios and use cases across a wide-range of tools, e.g., the request may be: to answer a question, to perform a purchase transaction or financial transaction (e.g., make a payment by transferring money or digital property such as cryptocurrency, move money between accounts, invoice or bill payments, send reminders for payments due, purchase or sell securities or other financial instruments), to perform research or information retrieval, to draft or modify (e.g., edit, copyedit, or revise) a document, to generate or modify video, audio, or multimodal content, to develop and/or test software or a software tool (e.g., perform code generation), to diagnose a medical or computer issue or identify one or more software bugs, to set a reminder, to schedule a meeting or appointment, to acquire and/or playback a media content item, to analyze data, to handle customer support or sales support queries, to automate repetitive processes (e.g., data entry, file conversion, or document routing), to assist in prototyping or design tasks, to perform monitoring or diagnostics of systems, to develop or devise strategy or planning, to detect fraud, misinformation, or deep-fakes, to perform educative or skill training tasks, to perform supply chain optimization, route planning or resource allocation, to perform threat analysis or surveillance, or to model complicated systems (e.g., global climate, physiological, or pharmacokinetic systems). These are just illustrative examples and are in no way meant to limit the types of natural language that may be processed by agentic AI system 200.

In 304, client 202 may use task language generator 201A to convert the natural language received from device 104 in 302 to a task language. The task language may be any suitable scheme that represents human language (e.g., requests, instructions, or commands) in a machine-readable format, enabling computers to work with humans using language and follow instructions in a broad context. The task language input may be represented as a binary vector. In one embodiment, the task language input may be generated using the TALAR method.

In 306, client 202 may transmit the task language representation via message bus 204 to primary agent node 206. In an embodiment, client 202 may serve as a publisher in an publisher/subscriber architecture employing an event bus. For example, message bus 204 may be Kafka-based solution. In an alternative embodiment, client 202 may transmit the task language representation via message bus 204 to all agents (i.e., primary agent node 206 and replica agent nodes 208A-208C).

In 308, primary agent node 206 may process the task language representation using its local computational model(s) to generate a proposed response to the task language representation. The proposed response may also be represented in the task language. Primary agent node 206 may employ any suitable computational models to determine the proposed response. For example, primary agent node 206 may employ an LLM, lightweight model, transformer-based model, state-spaced model, or other suitable model.

In 310, primary agent node 212 may transmit the generated response to replica agent nodes 208A-208C. Primary agent node 212 may sign the message with a digital signature using an appropriate cryptographic algorithm to allow other participants to verify the authenticity of the communication. Such a signature may rely on public key cryptography and primary agent node 212 may possess a private key used to generate signatures. Primary agent node 212 may assign a unique sequence number to the request. Primary agent node 212 may create a message containing the request, the sequence number, the signature of primary agent node 212, and the proposed response generated in 308. In an embodiment, primary agent node 212 may broadcast the signal proposal via a PBFT Pre-Prepare process or method.

In 312, replica agent nodes 208A-208C may verify the signature of primary agent node 212 in a received message using an appropriate cryptographic algorithm. Each agent in replica agent nodes 208A-208C may possess a public key that may be used to verify the signature of primary agent node 212. Replica agent nodes 208A-208C may also verify that the received sequence number is correct and has not been used before.

In 314, replica agent nodes 208A-208C may process the task language representation originally generated by client 202 and generate a suitable response to the task language representation. In an embodiment, the suitable response may also take the form of a task language representation. In this regard, each agent redundantly derives a candidate response to the task language.

In 316, replica agent nodes 208A-208C may compare the independently derived response with the proposed response broadcast by primary agent node 206 to determine if the proposed response generated in 314 matching the proposed response generated by primary agent node 212 in 308.

In 318, replica agent nodes 208A-208C may broadcast a message to all agents, including primary agent node 212 and the other replica agents in replica agent nodes 208A-208C. Replica agent nodes 208A-208C may create a message containing the request, the sequence number, the signature of the replica agent among replica agent nodes 208A-208C, and the result of the comparison in 316. If the proposed response broadcast by primary agent node 206 does not match the proposed response generated by the replica agent, then the message may further include an alternative response as determined by the replica agent. In an embodiment, the replica agent may broadcast the signal proposal via a PBFT Prepare process or method.

In 320, the agents may reach a quorum. Reaching a quorum may involve the agents cumulatively obtaining enough confirmations (i.e., via signed messages including matching proposed responses) to consider the proposed transaction to be valid, thus achieving a consensus among all of the nodes regarding a satisfactory response to the natural language request. In an embodiment using the PBFT algorithm, for 3f+1 nodes, a quorum may be reached if no less than 2f+1 nodes publish a prepare message indicating an agreement.

In 322, all agents may broadcast commit messages to all of the other agents. The commit message signals a final agreement on the satisfactory response. In an embodiment, the replica agent may broadcast the signal proposal via a PBFT Commit or method.

In 324, primary agent node 206 may transmit the validated, satisfactory response to client 202 via message bus 204. In an embodiment, primary agent node 206 may serve as a publisher in an publisher/subscriber architecture employing an event bus and client 202 may serve as a subscriber.

In 326, client 202 may convert the received, validated, satisfactory response from task language back to natural language. In 328, client 202 may return the natural language to device 104. For example, client 202 may present the natural language response to the user in a suitable interface, e.g., a virtual assistant.

FIG. 4 illustrates a method 400 for determining if a received natural language request is deterministic, according to some embodiments. Method 400 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art(s).

In 402, client 202 may receive a natural language request input into device 104. As discussed above, the natural language request may cover a wide-array of topics, subject matter, and may be presented in a variety of forms.

In 404, client 202 may determine if the query is deterministic or otherwise answerable by agentic AI system 200. As discussed above, agentic AI system 200 may be limited to specific types of queries. For example, deterministic or scientific questions may be answered, but agentic AI system 200 may not be able to process requests that are open-ended. In one embodiment, agentic AI system 200 may be able to determine whether a received request corresponds to capabilities of the task language based on the trained capabilities within the task language. For example, client 202 may determine that agentic AI system 200 may not be able to process a natural language request of “summarize the following document . . . (document),” but may be able to provide a deterministic answer to a natural language request of “is the topic of the following document the French Revolution . . . (document)”?

In 406, client 202 may route the query to an alternative natural language processing tool for processing. Such an alternative natural language processing tool may better provide an answer to an open-ended question. For example, the alternative natural language processing tool may be generative AI better suited to providing responses to open-ended natural language requests.

In 408, client 202 may proceed to send the natural language request to agentic AI system 200. For example, client 202 may proceed to use the method discussed above with reference to FIG. 3.

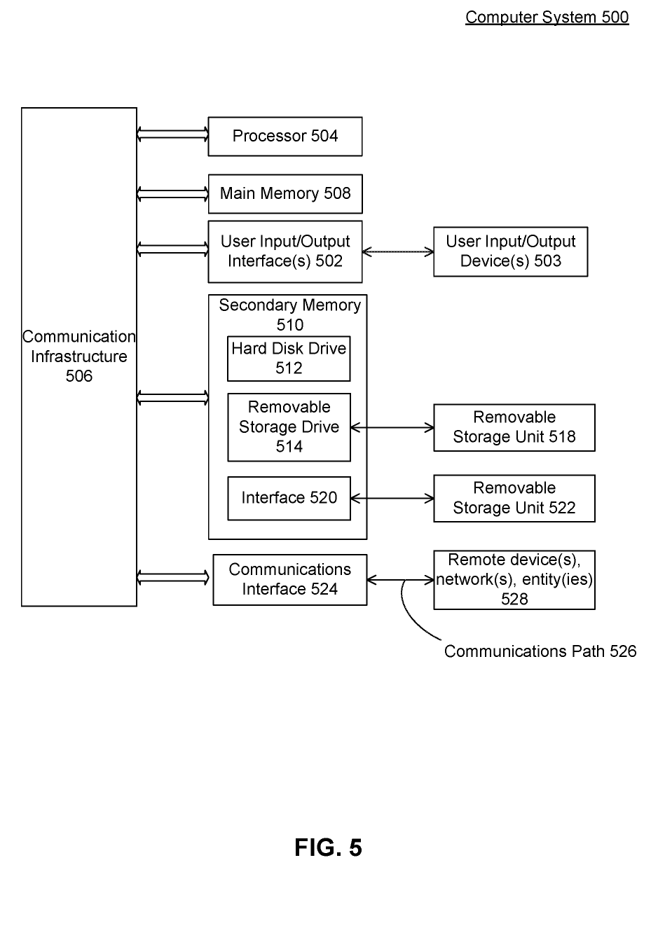

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof—e.g., agentic AI system 110 may be implemented via computer system 500. For further example, the methods illustrated in FIGS. 3 and 4 may be implemented via computer system 500, which may perform steps such as receiving a natural language request from a user; converting, using a task language generator, the natural language request into a task language input; transmitting the task language input to a plurality of agents, wherein each agent in the plurality of agents independently determines a response to the task language input; determining a satisfactory response by generating a quorum among the plurality of agents using a consensus algorithm based on the independently determined responses; converting the satisfactory response to a natural language response; and returning the natural language response to the user.

Computer system 500 may include one or more processors (also called central processing units, or CPUs), such as a processor 504. Processor 504 may be connected to a communication infrastructure 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/ any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method, comprising:
receiving, by one or more processors, a natural language request from a user;
converting, using a task language generator, the natural language request into a task language input;
transmitting the task language input to a plurality of agents, wherein each agent in the plurality of agents independently determines a response to the task language input;
determining a satisfactory response by generating a quorum among the plurality of agents using a consensus algorithm based on the independently determined responses;
converting the satisfactory response to a natural language response; and
returning the natural language response to the user.

2. The method of claim 1, wherein the natural language request is a transaction request and the natural language response is provided in response to the transaction request.

3. The method of claim 1, wherein each agent in the plurality of agents further comprises a language model and a task language library, each task language library being identical across the plurality of agents and each language model being identical across the plurality of agents.

4. The method of claim 1, wherein the task language input is represented as a binary vector.

5. The method of claim 1, the transmitting further comprising:
designating a primary node in the plurality of agents;
transmitting the task language input to the primary node; and
causing the primary node to transmit the task language input to other agents in the plurality of agents.

6. The method of claim 1, further comprising:
determining that the natural language request is a deterministic query.

7. The method of claim 1, wherein the consensus algorithm is a practical byzantine fault tolerance consensus protocol.

8. The method of claim 1, wherein the task language generator comprises a predicate representation scheme.

9. The method of claim 1, wherein the plurality of agents communicate via a message bus.

10. A system, comprising
a memory; and
at least one processor coupled to the memory and configured to:
receive a natural language request from a user;
convert, using a task language generator, the natural language request into a task language input;
transmit the task language input to a plurality of agents, wherein each agent in the plurality of agents independently determines a response to the task language input;
determine a satisfactory response by generating a quorum among the plurality of agents using a consensus algorithm based on the independently determined responses;
convert the satisfactory response to a natural language response; and
return the natural language response to the user.

11. The system of claim 10, wherein the natural language request is a transaction request and the natural language response is provided in response to the transaction request.

12. The system of claim 10, wherein each agent in the plurality of agents further comprises a language model and a task language library, each task language library being identical across the plurality of agents and each language model being identical across the plurality of agents.

13. The system of claim 10, wherein the task language input is represented as a binary vector.

14. The system of claim 10, wherein to transmit the task language input the at least one processor is further configured to:
designate a primary node in the plurality of agents;
transmit the task language input to the primary node; and
cause the primary node to transmit the task language input to other agents in the plurality of agents.

15. The system of claim 10, the at least one processor further configured to:
determine that the natural language request is a deterministic query.

16. The system of claim 10, wherein the consensus algorithm is a practical byzantine fault tolerance consensus protocol.

17. The system of claim 10, wherein the task language generator comprises a predicate representation scheme.

18. The system of claim 10, wherein the plurality of agents communicate via a message bus.

19. A non-transitory computer-readable medium having instructions stored thereon that, when executed by at least one computing device, cause the at least one computing device to perform operations, the operations comprising:
receiving a natural language request from a user;
converting, using a task language generator, the natural language request into a task language input;
transmitting the task language input to a plurality of agents, wherein each agent in the plurality of agents independently determines a response to the task language input;
determining a satisfactory response by generating a quorum among the plurality of agents using a consensus algorithm based on the independently determined responses;
converting the satisfactory response to a natural language response; and
returning the natural language response to the user.

20. The non-transitory computer-readable medium of claim 19, wherein each agent in the plurality of agents further comprises a language model and a task language library, each task language library being identical across the plurality of agents and each language model being identical across the plurality of agents.
